(19) United States
(12) Patent Application Publication
(10) Pub. No.: US 2024/0313256 A1
(43) Pub. Date: Sep. 19, 2024

(54) BATTERY FRAME, BATTERY MODULE AND MOVING OBJECT WITH BATTERY MODULE

(71) Applicant: HONDA MOTOR CO., LTD., Tokyo (JP)

(72) Inventor: Wataru Ohira, Wako-shi (JP)

(21) Appl. No.: 18/598,646

(22) Filed: Mar. 7, 2024

(30) Foreign Application Priority Data
Mar. 13, 2023 (JP) 2023-038210

(51) Int. Cl. H01M 10/04; H01M 10/6557; H01M 10/6567; H01M 50/202; H01M 50/249

(52) U.S. Cl. CPC H01M 10/0468; H01M 50/202; H01M 50/249; H01M 10/6557; H01M 10/6567; H01M 2220/20

(57) ABSTRACT

The moving object includes a battery module. A battery frame of the battery module has retaining plates and connecting members. The retaining plate has a central portion, a plurality of arms, and a plurality of attachment portions. A coupling member is attached to each of the plurality of attachment portions, so that a tightening load is applied to the cell stack body by an elastic deformation of the plurality of arms. A first dimension which is the thickness of the attachment portions in the stacking direction is smaller than a second dimension which is the thickness of the central portion in the stacking direction.

### CROSS-REFERENCE TO RELATED APPLICATIONS

This application is based upon and claims the benefit of priority from Japanese Patent Application No. 2023-038210 filed on Mar. 13, 2023, the contents of which are incorporated herein by reference.

### BACKGROUND OF THE INVENTION

### Field of the Invention

The present invention relates to a battery frame, a battery module and a moving object with the battery module.

### Description of the Related Art

JP 5393365 B2 discloses a battery module including a cell stack body formed by stacking a plurality of plate-like battery cells. For example, a tightening load is applied to such a cell stack body by the battery frame in the direction in which the battery cells are stacked.

### SUMMARY OF THE INVENTION

To provide a lightweight battery frame capable of efficiently applying a tightening load to a cell stack body.

The present invention has the object of solving the aforementioned problem.

A first aspect of the present invention is a battery frame for holding a cell stack body formed of a plurality of battery cells stacked one another, the battery frame including a pair of retaining plates made of metal, which are disposed on both sides of the cell stack body in a stacking direction of the plurality of battery cells, and a plurality of coupling members connecting the pair of retaining plates to each other to apply a tightening load from the pair of retaining plates to the cell stack body, wherein the pair of retaining plates each include a central portion positioned at a central part of each of the retaining plates, a plurality of arms extending radially outward from the central portion, and a plurality of attachment portions formed at extended ends of the plurality of arms, the plurality of coupling members are respectively attached to the plurality of attachment portions, an elastic deformation of the plurality of arms causes the tightening load to act on the cell stack body, and a first dimension as a thickness of the attachment portions in the stacking direction is smaller than a second dimension as a thickness of the central portion in the stacking direction.

A second aspect of the present invention is a battery module including the battery frame described above and the cell stack body.

A third aspect of the present invention is a moving object including the battery module described above.

According to the present invention, it is possible to efficiently apply a tightening load to the cell stack body while making the battery frame light in weight.

The above and other objects features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a perspective view of a battery module according to an embodiment of the present invention;

FIG. 2 is an exploded perspective view of the cell stack body;

FIG. 3 is a cross-sectional schematic view taken along line III-III of FIG. 1;

FIG. 4 is a partially omitted front view of the battery module;

FIG. 5 is a graph showing a change in the tightening load; and

FIG. 6 is a schematic diagram of an aircraft on which the battery module is mounted.

### DETAILED DESCRIPTION OF THE INVENTION

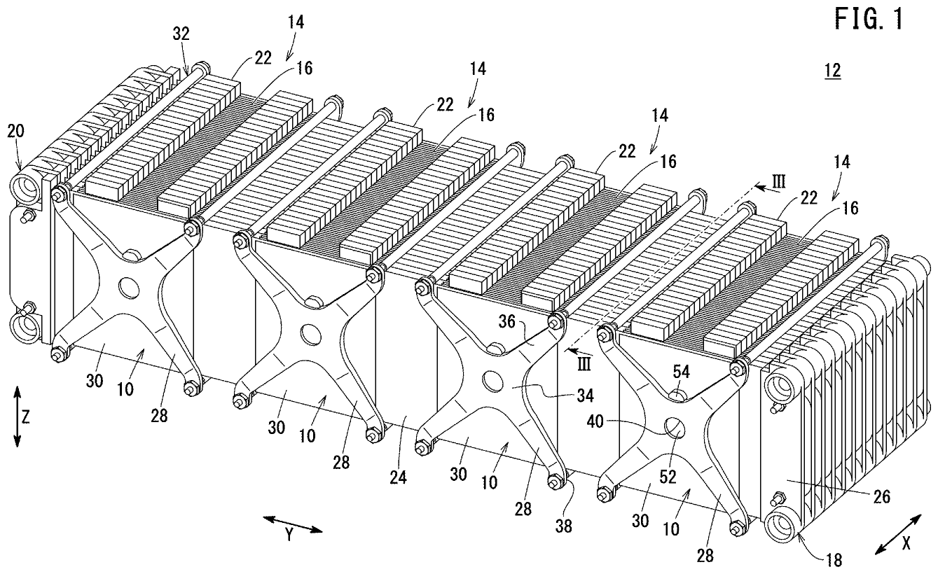

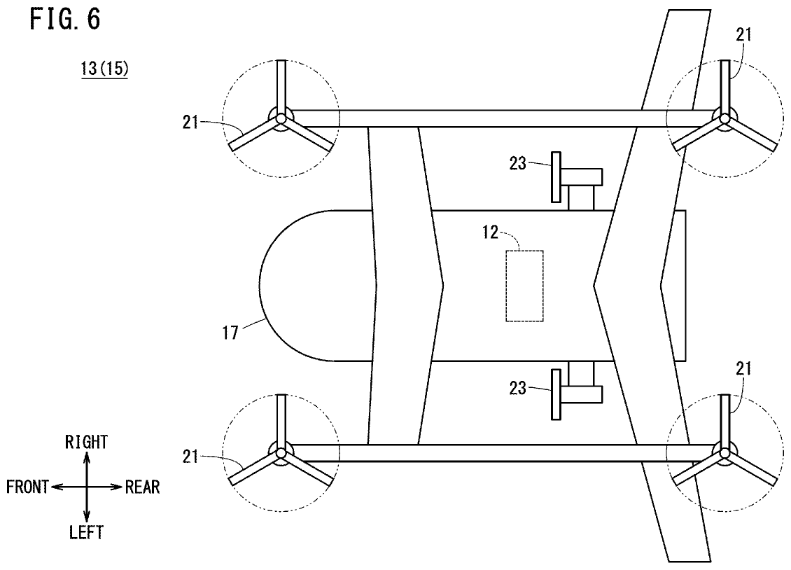

A battery frame 10, a battery module 12, and a moving object 13 with the battery module 12 according to an embodiment of the present invention will be described below with reference to the drawings. As shown in FIG. 1, the battery module 12 according to the present embodiment is mounted on, for example, an aircraft 15 as the moving object 13 depicted in FIG. 6. The aircraft 15 is, for example, an electric vertical take-off and landing (eVTOL) aircraft. The aircraft 15 includes a fuselage 17, a plurality of (for example, four) VTOL rotors 21, and a plurality of (for example, two) cruise rotors 23. The VTOL rotors 21 generate an upward thrust on the aircraft 15. The cruise rotors 23 generate a horizontal thrust on the aircraft 15. The battery module 12 is disposed inside the fuselage 17. The battery module 12 supplies electric power to an electric motor (not shown) that drives each of the VTOL rotors 21 and the cruise rotors 23. The moving object 13 may be, for example, a vehicle, a ship, or the like. The battery module 12 is not necessarily mounted on the moving object 13.

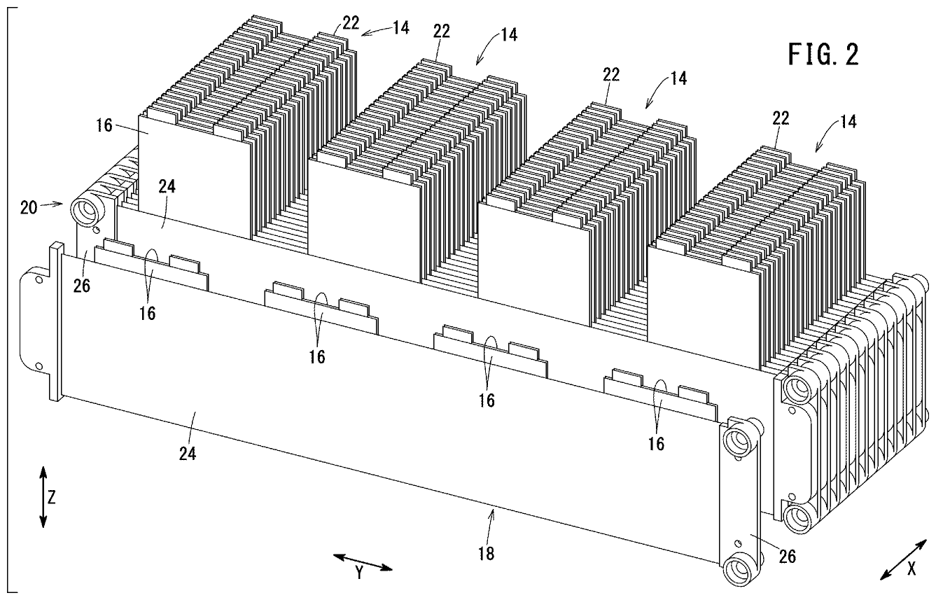

As shown in FIG. 1, the battery module 12 includes four cell stack bodies 14 and four battery frames 10. The four cell stack bodies 14 are arranged in the arrow Y direction. As shown in FIG. 2, the cell stack body 14 includes a plurality of battery cells 16, a plurality of first heat exchangers 18, and a plurality of second heat exchangers 20. The plurality of battery cells 16 are arranged in the arrow X direction.

The battery cell 16 is a laminated battery. The battery cell 16 is formed in a quadrangular plate shape. A plurality of terminal portions 22 protrude from one side of the battery cell 16 in the arrow Z direction. The plurality of battery cells 16 are connected in series to each other via the terminal portions 22. The terminal portions 22 are schematically illustrated.

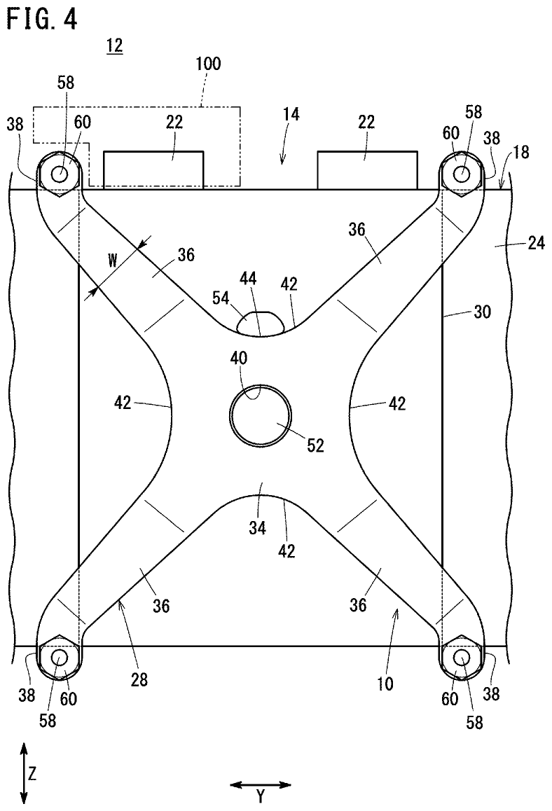

An electrical connection member (not shown) is joined to the plurality of terminal portions 22 by a bonding device 100 (see FIG. 4). The bonding device 100 is, for example, an ultrasonic bonding device. The bonding device 100 is not limited to the ultrasonic bonding device.

As shown in FIG. 2, the first heat exchanger 18 includes a plate-shaped water jacket 24 and a water supply and discharge header 26. The water jacket 24 extends in the arrow Y direction. Cooling water flows through a flow path formed inside the water jacket 24. The water supply and drainage header 26 is provided at one longitudinal end of the water jacket 24 (the arrow Y direction). The cooling water is supplied to and discharged from the water jacket 24 through the water supply and discharge header 26.

The second heat exchanger 20 is a similar in configuration to the first heat exchanger 18. The first heat exchangers 18 are arranged such that the water supply and discharge headers 26 are positioned at one end in the arrow Y direction. The second heat exchangers 20 are arranged such that the water supply and discharge headers 26 are positioned at the other end in the arrow Y direction. The first heat exchanger 18 and the second heat exchanger 20 are alternately arranged in the arrow X direction.

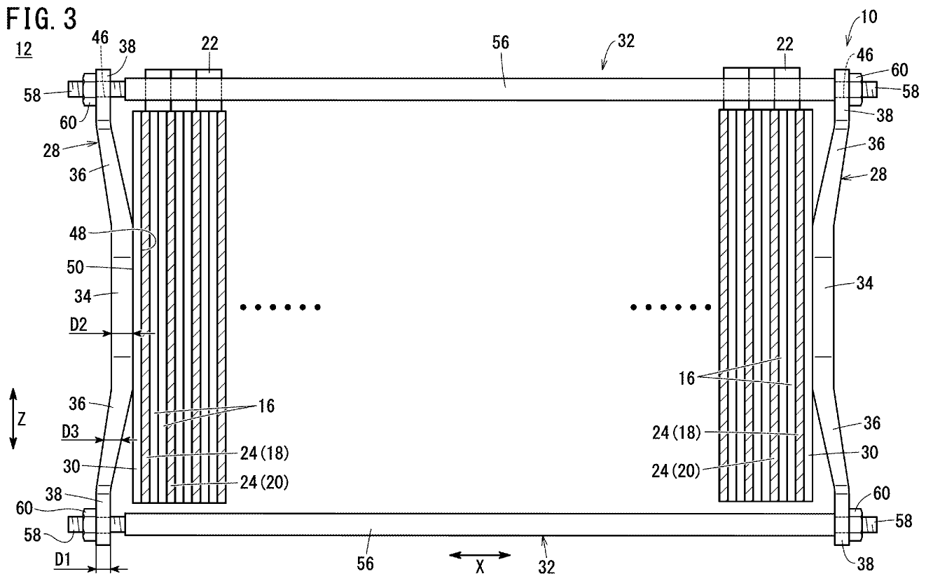

Two buttery cells 16 are stacked in the arrow X direction between the first heat exchanger 18 and the second heat exchanger 20 adjacent to each other (see FIG. 3). Four battery cells 16 are arranged in the arrow Y direction between the first heat exchanger 18 and the second heat exchanger 20 adjacent to each other.

As shown in FIGS. 1 and 3, the battery frame 10 holds the cell stack body 14. The battery frame 10 includes a pair of retaining plates 28, a pair of pressure receiving plates 30, and four coupling members 32. The pair of retaining plates 28 are respectively positioned at both ends of the battery module 12 in the arrow X direction. The pressure receiving plates 30 are disposed between the retaining plates 28 and the cell stack body 14. The coupling members 32 connect the pair of retaining plates 28 to each other so that the pair of retaining plates 28 apply a tightening load (compressive load) to the cell stack body 14. Thus, the expansion of the battery cells 16 are suppressed.

The pair of retaining plates 28 are positioned outward of the battery cells 16 in the stacking direction. The retaining plates 28 are made of, for example, a titanium alloy. The retaining plates 28 may be made of a metal material other than the titanium alloy.

As shown in FIG. 4, the retaining plate 28 is formed in an X shape when viewed from the thickness direction (the arrow X direction) of the retaining plate 28. The retaining plate 28 has a point-symmetrical shape. The retaining plate 28 includes a central portion 34, four arms 36, and four attachment portions 38.

The central portion 34 is located at the center part of the retaining plate 28. A circular through hole 40 is formed in the central portion 34. The through hole 40 reduces the weight of the retaining plate 28.

The four arms 36 extend radially outward from the central portion 34. The four arms 36 are provided at equal intervals in the circumferential direction of the central portion 34. The arm 36 has a width W that gradually decreases radially outward. The width direction of the arm 36 intersects the extending direction of the arm 36 and the stacking direction of the battery cells 16 (the arrow X direction). The arm 36 functions as a plate spring that is elastically deformed when a tightening load is applied to the cell stack body 14.

A cut-away portion 42 is formed between the arms 36 adjacent to each other. The cut-away portion 42 is formed in a triangular shape when the retaining plate 28 is viewed from the thickness direction. The central portion 34 is formed by arc-shaped surfaces 44 of the cut-away portions 42. The radius of curvature of the arc-shaped surface 44 is larger than the radius of the through hole 40.

The attachment portion 38 is provided at an extended end of the arm 36. The attachment portion 38 protrudes from the extended end of the arm 36 along the arrow Z direction (the direction in which the terminal portions 22 protrude). The coupling member 32 is connected to the attachment portion 38. An insertion hole 46 through which a bolt 58 of the coupling member 32 is inserted is formed in the attachment portion 38 (see FIG. 3).

The attachment portion 38 is positioned outwardly of the cell stack body 14 when viewed in the stacking direction of the battery cells 16 (the arrow X direction). In other words, the attachment portions 38 do not overlap the terminal portions 22 when viewed from the arrow X direction. This makes it possible to avoid interference between the bonding device 100 and the attachment portions 38 when the terminal portions 22 are joined to the electrical connection member (not shown).

As shown in FIG. 3, a first dimension D1, which is the thickness of the attachment portion 38 in the stacking direction of the battery cells 16, is smaller than a second dimension D2, which is the thickness of the central portion 34 in the stacking direction of the battery cells 16. In other words, the attachment portion 38 is thinner than the central portion 34. Therefore, the weight of the retaining plate 28 can be reduced as compared with the case where both the attachment portion 38 and the central portion 34 have the same thickness. The first dimension D1 is set to be, for example, 70% or less of the second dimension D2. The ratio of the first dimension D1 to the second dimension D2 is determined as necessary.

A third dimension D3, which is the thickness of the arm 36 in the stacking direction of the battery cells 16, is larger than the first dimension D1 and smaller than the second dimension D2. To be specific, the third dimension D3 gradually decreases from the central portion 34 toward the attachment portion 38. The third dimension D3 decreases linearly from the central portion 34 toward the attachment portion 38. The third dimension D3 may decrease quadratically from the central portion 34 toward the attachment portion 38.

As shown in FIGS. 3 and 4, the pressure receiving plates 30 are provided for pressing the cell stack body 14 uniformly by the tightening load applied from the retaining plates 28. The pressure receiving plate 30 is formed in a quadrangular shape. As shown in FIG. 3, a first surface 48 of the pressure receiving plate 30 is in surface contact with an end surface of the cell stack body 14. The central portion 34 of the retaining plate 28 is in surface contact with a second surface 50 of the pressure receiving plate 30 opposite to the first surface 48.

The planar dimension of the pressure receiving plate 30 is substantially the same as the planar dimension of the battery cell 16. The planar dimension of the pressure receiving plate 30 may be larger or smaller than the planar dimension of the battery cell 16. The pressure receiving plate 30 is made of, for example, lightweight metal such as aluminum. The material for the pressure receiving plate 30 is not limited to metal and may be resin or a composite material.

As shown in FIG. 4, the pressure receiving plate 30 is provided with a center projection 52 and a positioning projection 54. The center projection 52 projects outward in the stacking direction of the battery cells 16 from the central part of the pressure receiving plate 30. The center projection 52 is formed in a columnar shape. The center projection 52 is inserted into the through hole 40 of the central portion 34 of the retaining plate 28. Thus, the central portion 34 of the retaining plate 28 can be easily positioned in alignment with the central portion of the pressure receiving plate 30 when the battery frame 10 is assembled.

The positioning projection 54 projects outward in the stacking direction of the battery cells 16 from a position shifted from the center of the pressure receiving plate 30. The positioning projection 54 engages with the cut-away portion 42 of the retaining plate 28. In other words, the positioning projection 54 is in contact with the arc-shaped surface 44 of the central portion 34. Thus, the retaining plate 28 can be positioned with respect to the pressure receiving plate 30 in the circumferential direction of the center projection 52 when the battery frame 10 is assembled. The positioning projection 54 also functions as a rotation stopper that prevents the retaining plate 28 from rotating in the circumferential direction of the center projection 52.

In a state where the retaining plate 28 is attached to the pressure receiving plate 30, the four arms 36 extend so as to overlap with the four corners of the pressure receiving plate 30, respectively, when viewed from the arrow X direction. In a state where the retaining plate 28 is attached to the pressure receiving plate 30, there is a gap between the arms 36 and the corners of the pressure receiving plate 30 in the stacking direction. In a state where the retaining plate 28 is attached to the pressure receiving plate 30, the four attachment portions 38 are positioned outwardly of the pressure receiving plate 30 when viewed from the arrow X direction.

As shown in FIG. 3, the coupling member 32 includes a coupling shaft 56, two bolts 58, and two nuts 60. The coupling shaft 56 extends along the stacking direction of the battery cells 16. The coupling shaft 56 is made of metal such as stainless steel. The bolts 58 protrude from end surfaces of the coupling shaft 56 in the axial direction. The bolts 58 are inserted into the insertion holes 46 of the attachment portions 38 of the retaining plate 28. The nuts 60 are screwed onto the bolts 58. The attachment portion 38 is positioned between the nut 60 and the coupling shaft 56.

When the nuts 60 are fastened to the bolts 58, the retaining plate 28 is pressed toward the pressure receiving plate 30. At this time, the four arms 36 are elastically deformed. The elastic force (spring force) of the four arms 36 acts on the cell stack body 14 as a tightening load via the pressure receiving plate 30.

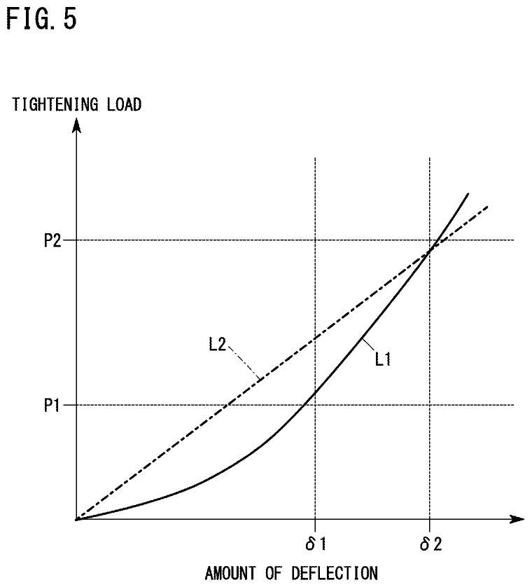

FIG. 5 shows experimental results indicating changes in the tightening load when the nuts 60 are fastened to the bolts 58. The horizontal axis of the graph of FIG. 5 represents the amount of deflection of the retaining plate 28 after the tightening load is applied. The vertical axis of the graph of FIG. 5 represents the tightening load. The line segment L1 represents an experimental result of the battery frame 10 according to the present embodiment. The line segment L2 represents an experimental result of the battery frame 10 according to a comparative example. The battery frame 10 according to the comparative example is configured similarly to the battery frame 10 according to the present embodiment, except that each of the first dimension D1 and the second dimension D2 of the retaining plate 28 is set to the same thickness as the third dimension D3.

In FIG. 5, a first tightening load P1 is a lower limit value of the tightening load required for the battery cells 16. The second tightening load P2 is an upper limit value of the tightening load allowable for the battery cells 16. The first amount of deflection 81 is the maximum amount of deflection of the retaining plate 28 when the manufacturing tolerance of the cell stack body 14 in the stacking direction of the battery cells 16 is minimum. The second amount of deflection 82 is the maximum amount of deflection of the retaining plate 28 when the manufacturing tolerance of the cell stack body 14 in the stacking direction of the battery cells 16 is maximum and the battery cells 16 are bulged maximally while in use.

As shown in FIG. 5, in the battery frame 10 (line segment L1) according to the present embodiment, the tightening load increased quadratically as the amount of deflection of the retaining plate 28 increased. The line segment L1 according to the present embodiment shows that a tightening load in the range between the first tightening load P1 and the second tightening load P2 was obtained in the range from the first amount of deflection 81 to the second amount of deflection 82.

On the other hand, in the battery frame 10 (line segment L2) according to the comparative example, the tightening load increased linearly as the amount of deflection of the retaining plate 28 increased. The line segment L2 according to the comparative example shows that the tightening load in the range between the first tightening load P1 and the second tightening load P2 was obtained in the range from the first amount of deflection 81 to the second amount of deflection 82.

The tightening load of the line segment L1 was smaller than the tightening load of the line segment L2 in a range where the amount of deflection was smaller than the second amount of deflection 82. That is, according to the experimental results of FIG. 5, the tightening load applied to the cell stack body 14 effectively suppressed as compared with the comparative example was obtained. In other words, the present embodiment exhibited an effect that the tightening load can be efficiently applied to the cell stack body 14. In this case, the rigidity of the retaining plate 28 and the pressure receiving plate 30 does not have to be increased more than necessary, and thus the retaining plate 28 and the pressure receiving plate 30 can be made thin. Therefore, the battery frame 10 can be made lightweight.

The present embodiment is not limited to the above-described configuration. The width W of the arm 36 may be constant from the central portion 34 toward the attachment portion 38. The third dimension D3 of the arm 36 may be reduced in a stepwise manner from the central portion 34 toward the attachment portion 38. The third dimension D3 may be a constant value from the central portion 34 to the attachment portion 38. The third dimension D3 may be the same as one of the first dimension D1 and the second dimension D2. The number of the arms 36 is not limited to four, and may be three, five, or more. The number of each of the cell stack bodies 14 and the battery frames 10 forming the battery module 12 is not limited to four, and may be any integer other than zero. The cell stack body 14 may not include the first heat exchanger 18 and the second heat exchanger 20. The battery frame 10 may not include the pressure receiving plate 30.

In addition to the above disclosure, the following appendices are further disclosed.

### APPENDIX 1

The battery frame (10) for holding a cell stack body (14) formed of a plurality of battery cells (16) stacked one another, the battery frame including: the pair of retaining plates (28) made of metal, which is disposed on both sides of the cell stack body in a stacking direction of the plurality of battery cells: and the plurality of coupling members (32) connecting the pair of retaining plates to each other to apply a tightening load from the pair of retaining plates to the cell stack body, wherein the pair of retaining plates each include: a central portion (34) positioned at a central part of each of the retaining plates, the plurality of arms (36) extending radially outward from the central portion, and the plurality of attachment portions (38) formed at the extended ends of the plurality of arms, the plurality of coupling members are respectively attached to the plurality of attachment portions, the elastic deformation of the plurality of arms causes the tightening load to act on the cell stack body, and the first dimension (D1) as the thickness of the attachment portions in the stacking direction is smaller than the second dimension (D2) as the thickness of the central portion in the stacking direction.

According to such a configuration, the weight of the retaining plates (battery frame) can be reduced as compared with a case where the first dimension of the attachment portion is set to be the same as the second dimension of the central portion. Further, the elastic deformation of the arm realizes efficient application of the tightening load to the cell stack body.

### APPENDIX 2

In the battery frame according to Appendix 1, the third dimension (D3) as the thickness of the arm in the stacking direction may be larger than the first dimension and smaller than the second dimension.

According to such a configuration, the battery frame can be further reduced in weight.

### APPENDIX 3

In the battery frame according to Appendix 2, the third dimension may gradually decrease from the central portion toward the attachment portion.

According to such a configuration, the battery frame can be further reduced in weight. Further, since the tightening load acting on the cell stack body can be changed quadratically, the tightening load can be applied to the cell stack body more efficiently.

### APPENDIX 4

In the battery frame according to any one of Appendixes 1 to 3, the cut-away portion (42) may be formed between the arms adjacent to each other.

According to such a configuration, the weight of the retaining plate can be reduced by the cut-away portion.

### APPENDIX 5

The battery frame according to any one of the Appendixes 1 to 4 may include the pressure receiving plate (30) configured to be brought into surface contact with an end surface of the cell stack body, between the retaining plate and the cell stack body. According to such a configuration, the tightening load can be uniformly applied to the cell stack body by the pressure receiving plate.

### APPENDIX 6

In the battery frame according to Appendix 5, the pressure receiving plate may be provided with the positioning projection (54) in engagement with the cut-away portion to position the retaining plate.

According to such a configuration, the retaining plate can be easily and accurately assembled to the pressure receiving plate.

### APPENDIX 7

In the battery frame according to any one of Appendixes 1 to 6, in a state where the pair of retaining plates hold the cell stack body of the battery cells having terminal portions (22) protruding from the battery cells in a direction intersecting the stacking direction, the attachment portions may protrude from the arms along a direction the same as the direction in which the terminal portions protrude, but so as not to overlap with the terminal portion when viewed from the stacking direction.

According to such a configuration, it is possible to avoid the bonding device and the terminal portion from interfering with each other when the terminal portion is joined to the electrical connection member.

### APPENDIX 8

In the battery frame according to any one of Appendixes 1 to 7, the width (W) of the arms in a direction intersecting both the extending direction of the arms and the stacking direction may be gradually reduced toward the attachment portions.

According to such a configuration, the battery frame can be further reduced in weight.

### APPENDIX 9

The battery module (12) includes the battery frame according to any one of Appendixes 1 to 8, and the cell stack body.

### APPENDIX 10

The moving object (13) includes the battery module according to Appendix 9.

Moreover, it should be noted that the present invention is not limited to the disclosure described above, and various configurations may be adopted therein without departing from the essence and gist of the present invention.

1. A battery frame for holding a cell stack body formed of a plurality of battery cells stacked one another, comprising:
a pair of retaining plates made of metal, which is disposed on both sides of the cell stack body in a stacking direction of the plurality of battery cells; and
a plurality of coupling members connecting the pair of retaining plates to each other and configured to apply a tightening load from the pair of retaining plates to the cell stack body, wherein
the pair of retaining plates each comprise:
a central portion positioned at a central part of each of the retaining plates,
a plurality of arms extending radially outward from the central portion, and
a plurality of attachment portions formed at extended ends of the plurality of arms,
the plurality of coupling members are respectively attached to the plurality of attachment portions,
an elastic deformation of the plurality of arms causes the tightening load to act on the cell stack body, and
a first dimension as a thickness of the attachment portions in the stacking direction is smaller than a second dimension as a thickness of the central portion in the stacking direction.

2. The battery frame according to claim 1, wherein
the third dimension as a thickness of the arms in the stacking direction is larger than the first dimension and smaller than the second dimension.

3. The battery frame according to claim 2, wherein
the third dimension gradually decreases from the central portion toward the attachment portions.

4. The battery frame according to claim 1, wherein
a cut-away portion is formed between the arms adjacent to each other.

5. The battery frame according to claim 4, further comprising:
a pressure receiving plate configured to be brought into surface contact with an end surface of the cell stack body, between the retaining plate and the cell stack body.

6. The battery frame according to claim 5, wherein
the pressure receiving plate is provided with a positioning projection in engagement with the cut-away portion to position the retaining plate.

7. The battery frame according to claim 1, wherein
in a state where the pair of retaining plates hold the cell stack body of the battery cells having terminal portions protruding from the battery cells in a direction intersecting the stacking direction, the attachment portions protrude from the arms along a direction same as the direction in which the terminal portions protrude, but so as not to overlap with the terminal portions when viewed from the stacking direction.

8. The battery frame according to claim 1, wherein
a width of the arms in a direction intersecting both an extending direction of the arms and the stacking direction is gradually reduced toward the attachment portions.

9. A battery module comprising:
a battery frame according to claim 1; and
the cell stack body.

10. A moving object comprising the battery module according to claim 9.
